(19) United States
(12) Patent Application Publication
(10) Pub. No.: US 2012/0259813 A1
(43) Pub. Date: Oct. 11, 2012

(54) INFORMATION PROCESSING SYSTEM AND DATA PROCESSING METHOD

(75) Inventors: Masanori Takata, Yokohama (JP); Yohsuke Ishii, Yokohama (JP); Tomonori Esaka, Kawasaki (JP); Atsushi Sutoh, Yokohama (JP)

(73) Assignee: Hitachi, Ltd.

(21) Appl. No.: 13/125,574

(22) PCT Filed: Apr. 8, 2011
(86) PCT No.: PCT/JP2011/002101

§ 371 Date: Apr. 21, 2011

(51) Int. Cl. G06F 17/30; G06F 15/16

(52) U.S. Cl. 707/622; 707/827; 707/E17.005; 707/E17.01

(57) ABSTRACT

The file synchronization processing among sites which can reduce the response time is realized. By the CAS device creating a list of at least a part of the file groups which the first sub-computer system archived or backed up to the data center as an update list and transferring the update list to the second sub-computer system, the second sub-computer system determines whether the file is valid or not by using the update list (See FIG. 2).

### TECHNICAL FIELD

The present invention relates to an information processing system and a data processing method in the relevant system and, for example, relates to a technology for sharing data in a NAS-CAS integration.

### BACKGROUND ART

The amount of digital data, especially of file data, is rapidly increasing. NAS (Network Attached Storage) is a storage device appropriate for a large number of computers to share file data via a network.

Digital data including file data must be stored over a long period for satisfying various types of legal requirements for example. CAS (Content Addressed Storage) guarantees data invariance and provides solutions for long-term data archiving. Generally, currently used data is stored in a NAS device as long as the data is used, and subsequently is migrated to a CAS device for the purpose of archiving. Migrated data is also referred to as archive data. For example, e-mail data in the NAS device might be archived to the CAS device for compliance with the law. The data stored in the CAS device is not limited to archive data. By migrating data stored in the NAS device in accordance with a policy, for example, by migrating the data which is not accessed for a certain period of time and others to the CAS device, the capacity of the NAS device can be kept small. Furthermore, the data stored in the NAS device can be copied to the CAS device for the purpose of backup.

If a data file is archived, the path name of the archived file is changed. For example, the path name of a file A is changed from //NAS-A/share/fileA to //CAS-A/archive/fileA. At this step, by the NAS device generating stub information including the changed path name of the file (referred to as stub or also as stub data), the client can access the file by using the path name of the file before the change. If the archived file is accessed, the NAS device recalls (also referred to as “restores”) the file data of the required file from the CAS device by using the stub information, and stores the same in the NAS device. Furthermore, the NAS device and the CAS device can integrate name spaces by using GNS (Global Namespace).

The Patent Literature 1 discloses the technology in which the above-mentioned NAS-CAS integration determines whether an access from the NAS client is a normal NAS access or a special NAS access for the purpose of backup and, if [the access is] for the purpose of backup, the actual archive data existing in the CAS device is not backed up and only the stub information is backed up.

A system (a NAS-CAS integrated storage system) in which a CAS device is located in a data center, NAS devices are located in respective sites (e.g. respective divisions of a company), the CAS device and the NAS devices are connected via a communication network such as WAN (Wide Area Network), and the distributed data in the NAS devices is centrally managed in the CAS device exists. The data in the NAS devices is archived or backed up to the CAS device by a certain trigger. If the file which is accessed by the client is archived, the file data is not stored in the NAS devices (stub), and therefore the NAS devices must recall the file data from the CAS device. Meanwhile, if the file accessed by the client is backed up, the file data is stored in the NAS devices, and the NAS devices do not have to recall the file data from the CAS.

Generally, in the above-mentioned system, as some of files which the respective sites own are not desired to be referred to from the other sites, the CAS device comprises a TENANT function which creates a TENANT for permitting accesses from a specific site only. By making [the ratio of] the site:TENANT=1:1 with consideration for security, each of the sites structures a dedicated file system for the local sites in the TENANT.

Meanwhile, there are cases where it is desired to refer to files in the other sites. Even in cases of a file access from the other sites, the CAS device can make the files in the other sites referable by permitting the access, and file sharing among remote sites via the data center can be realized.

As a technology for copying differences among file systems, the Patent Literature 2 discloses the technology of comparing the hierarchical relationships of tree structures in two different file systems by using hash values, creating an update file list of the update target files of different hash values, and copying the updated file group to the other file system.

### CITATION LIST

### Patent Literature

[PTL 1] US Patent Application No. US 2009/0319736 A1
[PTL 2] Japanese Patent Application Laid-Open (Kokai) No. 2008-250903

### SUMMARY OF INVENTION

### Technical Problem

In the system described in the Patent Literature 1, the system in which the data in the NAS devices is archived or backed up to the CAS device (data center) is referred to as a first sub-computer system. The first sub-computer system includes NAS devices and one or a plurality of clients. The system of referring to the data which the first sub-computer system archived or backed up to the CAS device is referred to as a second sub-computer system or the site B. The second sub-computer system includes NAS devices and one or a plurality of clients.

However, in the system described in the Patent Literature 1, if the client of the site B makes an access request to a file in the site A, the NAS device of the site B copies the relevant file in the CAS device to the file system in the NAS device of the site B, and responds to the client. Subsequently, the original file which is copied to the site B and is stored in the CAS device might be updated by the archive or backup processing of the site A. Due to this, the contents might be different between the file in the NAS device of the site B and the file in the CAS device.

Furthermore, if the file update method of the Patent Literature 2 is to be applied to the system of the Patent Literature 1, all the updated files in the CAS device are supposed to be copied to the NAS device of the site B by the archive or backup processing of the site A. Though this method makes it possible to identify the updated file group by comparing the file group in the CAS device and the file group in the NAS device in the sites, all the updated files in the CAS device are supposed to be copied to the NAS device of the site B, and therefore there is a problem that the capacity of the file system of the NAS device in the site B is consumed. Furthermore, there is a problem that, even if it is not desired to overwrite a file before the update stored in the NAS device of the site B, the file of the same path name is overwritten with the updated file.

Furthermore, if the client of the site B refers to a file of the site A, the method by which the NAS device of the site B continuously acquires file data from the CAS device might cause the deterioration of the access performance because the NAS device must recall the file data from the CAS device regardless of whether the relevant file is stored in the NAS device or not.

The method in which, if the client of the site B refers to a file of the site A which is already stored in the NAS device of the site B, the NAS device of the site B inquires with the CAS device about whether the relevant file is valid or not and, if the [file is] valid, returns the relevant file which is already stored in the NAS device of the site B to the client or, if [the file is] not valid, acquires the file data from the CAS device, updates the same, and returns the same to the client can be considered. For determining whether the relevant file is valid or not, the attribute information such as the last update date and time of the file is used. By this method, the communication between the NAS device of the site B and the CAS device of the data center occurs each time the site B accesses a file of the site A from the client of the site B, which might cause the deterioration of the response time.

The present invention is created in view of such circumstances, prevents the waste of the capacity of the NAS devices, shortens the response time, and furthermore provides the file sharing technology by which the version control of files is possible.

### Solution to Problem

For solving at least one of the above-mentioned problems, by the present invention, the CAS device creates a list of at least a part of the file group which the first sub-computer system archived or backed up to the data center as an update list and transfers the same to the second sub-computer system, by which the second sub-computer system determines whether the file is valid or not by using the update list.

An aspect of the present invention is that the second sub-computer system retains the above-mentioned update list as an update table and, if a file which is already stored in the second sub-computer system is accessed, the second sub-computer system refers to the update table and determines whether [the file is] valid or not. If the relevant file is valid as a result of the reference, that is, if the contents are the same as the file in the data center, the second sub-computer system can respond to the client without communicating with the data center. Meanwhile, if the relevant file is not valid, that is, if the contents are different from the file in the data center, the second sub-computer system acquires the file data from the CAS device, updates the contents of the file system, and returns the same to the client. At this step, the existing file which is already stored is not overwritten and is stored as a file which has the same path name but is of another version.

According to another aspect of the present invention, the second sub-computer system determines whether the file group which is already stored in the second sub-computer system is valid or not after acquiring the update list from the CAS device. For the files updated in the CAS device, the second sub-computer system invalidates (e.g. deletes) or updates the stored files.

According to another aspect of the present invention, the file which the first sub-computer system updated is immediately archived or backed up to the CAS device, the CAS device transfers the relevant file to the second sub-computer system, and the second sub-computer system immediately updates the relevant file. At this step, the existing file which is already stored is not overwritten and is stored as a file which has the same path name but is of another version.

Further characteristics related to the present invention are partially explained clearly in the description that follows, partially made obvious by this description, or can be learned by practicing the present invention. The aspects of the present invention are achieved and realized by the components, combinations of the various components, the detailed description below, and the aspects of claims which are attached.

It is required to understand that the description above and below is merely typical and intended for explanation, and is by no means intended to limit the claims and the applications of the present invention.

### Advantageous Effects of Invention

According to the present invention, it becomes possible to share files among remote sites, shorten the response time of access to the files in the remote sites, and also improve the access performance. Furthermore, it becomes possible to manage the versions of the files in each of the sites.

### BRIEF DESCRIPTION OF DRAWINGS

FIG. 1 is a diagram showing the physical schematic configuration of the information processing system by the present invention.

FIG. 2 is a diagram showing the logical configuration of the information processing system by the present invention.

FIG. 3 is an example of a pattern diagram showing the frame format of the time chart of file write processing, migration processing, read processing, and data synchronization processing in the present invention.

FIG. 4 is a diagram showing the hardware configuration and the software configuration of the NAS device.

FIG. 5 is a diagram showing the hardware configuration and the software configuration of the CAS device.

FIG. 6 is a diagram showing a configuration example of a remote site update list table.

FIG. 7 is a diagram showing a configuration example of a local site update list table.

FIG. 8 is a diagram showing a configuration example of a site-specific update list table.

FIG. 9 is a flowchart for explaining file read processing by the present invention.

FIG. 10 is a flowchart for explaining data synchronization processing by the Embodiment 1 of the present invention.

FIG. 11 is a flowchart for explaining file write processing by the present invention.

FIG. 12 is a flowchart for explaining data deletion processing by the present invention.

FIG. 13 is a flowchart for explaining migration processing by the present invention.

FIG. 14 is a flowchart for explaining the batched processing of data synchronization by the Embodiment 2 of the present invention.

FIG. 15 is a flowchart for explaining original file write processing by the Embodiment 3 of the present invention.

FIG. 16 is a flowchart for explaining the details of real-time synchronization processing by the Embodiment 3 of the present invention.

FIG. 17 is a diagram for explaining the characteristics of the processing overview in the Embodiment 1 of the present invention.

FIG. 18 is a diagram for explaining the characteristics of the processing overview in the Embodiment 2 of the present invention.

### DESCRIPTION OF EMBODIMENTS

The present invention generally relates to a technology for managing data in the storage system of a computer and, more specifically, relates to a technology for transferring data stored in the NAS (Network Attached Storage) [devices] to the CAS (Content Addressed Storage) [device] and sharing the data among the NAS [devices].

Hereinafter, the embodiments of the present invention are explained with reference to the attached figures. In the attached figures, the components which are functionally equal might be referred to by the same number. It should be noted that the attached figures show concrete embodiments and implementation examples complying with the principle of the present invention, but that these are for the ease of understanding the present invention and is by no means used for any limited interpretation of the present invention.

Though these embodiments are explained in enough detail for those skilled in the art to practice the present invention, it must be understood that other implementations and embodiments are also possible and that it is possible to change the configuration and the structure and to replace various components within the spirit and scope of the technical idea of the present invention. Therefore, the description below must not be interpreted limited to these [embodiments].

Furthermore, as explained later, the embodiments of the present invention may also be implemented by the software operating in the general-purpose computer, by dedicated hardware, or by a combination of the software and the hardware.

It should be noted that, though the information used by the present invention is explained with tables and lists as examples in the figures of this description, [the information] is not limited to the information provided in the table and list structures, the information which does not depend on the data structure may also be permitted.

Furthermore, the expressions of “identification information”, “identifier”, “name”, “appellation”, and “ID” are used for explaining the contents of each types of information, and it is possible to replace these mutually.

In the embodiments of the present invention, the communication network for the NAS and CAS [devices] is not limited to the adoption of WAN, and it may also be permitted to adopt the communication network such as LAN (Local Area Network). An aspect of the present invention is not limited to the adoption of the NFS (Network File System) protocol, and it may also be permitted to adopt other file sharing protocols including CIFS (Common Internet File System), HTTP (Hypertext Transfer Protocol), and others.

In the explanation below, the processing might be explained by a “program” as a subject, but the subject of the explanation may also be processor because the program performs the specified processing by being performed by the processor while using a memory and a communication port (a communication control device). Furthermore, the processing which is disclosed with a program as the subject may also be considered to be the processing performed by a computer and an information processing device such as a management server. A part or all of the programs may be realized by dedicated hardware or may also be modularized. Various types of programs may also be installed in the respective computers by a program distribution server or storage media.

### (1) Embodiment 1

### Physical System Configuration

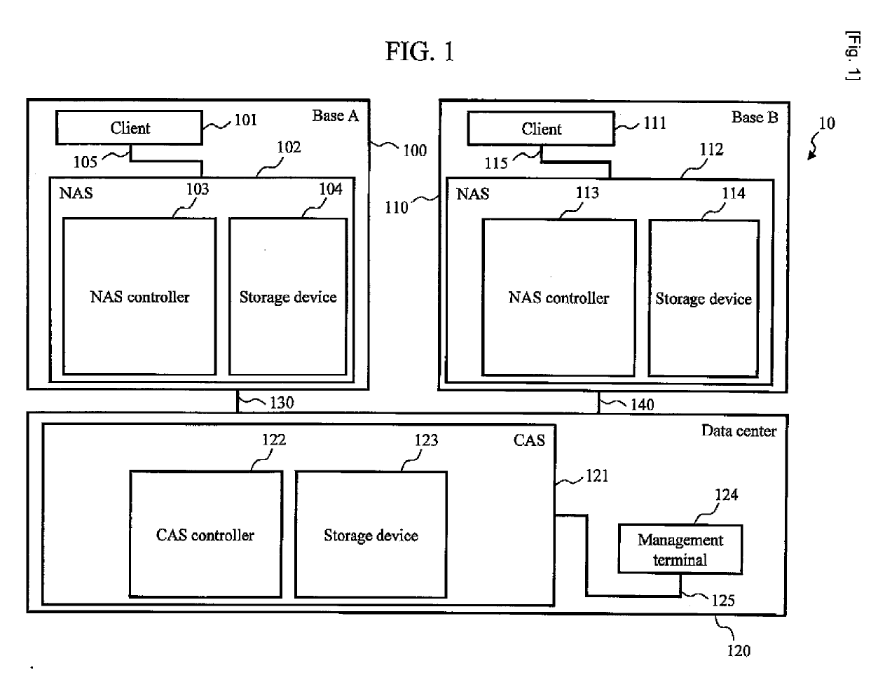

FIG. 1 is a block diagram showing an example of the physical configuration of the system by the embodiment of the present invention (referred to as an information processing system, an integrated storage system, or a computer system). It should be noted that, though only the site A and the site B are shown in FIG. 1, more sites may also be included in the system, and the configuration of each of the sites can be made similar. Furthermore, although the case where the site B refers to and uses files in the site A is explained in the embodiment, no priority (parent-child relationship) exists in any of the sires and the same operation is performed even if the site A refers to and uses the files in the site B.

The relevant computer system 10 comprises one or more sub-computer systems 100 and 110 located in each of the sites and a data center system 120 configured of a CAS device 121, and each of the sub-computer systems 100 and 110 and the data center system 120 are connected via networks 130 and 140.

The sub-computer systems 100 and 110 comprise clients 101 and 111 and NAS devices 102 and 112, which are connected via networks 105 and 115. The clients 101 and 111 are one or more computers utilizing the file sharing service provided by the NAS devices 102 and 112. The clients 101 and 111 utilize the file sharing service provided by the NAS devices 102 and 112 via the networks 105 and 115 by utilizing the file sharing protocols such as NFS (Network File System) and CIFS (Common Internet File System).

The NAS devices 102 and 112 comprise NAS controllers 103 and 113 and storage devices 104 and 114. The NAS controllers 103 and 113 provide the file sharing service to the clients 101 and 111, and also comprise the collaboration function with the CAS device 121. The NAS controllers 103 and 113 store various types of files and file system configuration information which the clients 101 and 111 create in the storage devices 104 and 114.

The storage devices 104 and 114 provide volumes to the NAS controllers 103 and 113, and the NAS controllers 103 and 113 store the various types of files and file system configuration information in the same.

The data center 120 comprises a CAS device 121 and a management terminal 124, which are connected via a network 125. The CAS device 121 is a storage device which is the archive and backup destination of the NAS devices 102 and 112. The management terminal 124 is a computer used by the administrator managing the computer system 10. The administrator manages the CAS device 121 and the NAS devices 102 and 112 from the management terminal 124 via the network 125. The management of the same is, for example, starting to operate the file server, terminating the file server, managing the accounts of the clients 101 and 111, and others. It should be noted that the management terminal 124 comprises an input/output device. As examples of the input/output devices, a display, a printer, a keyboard, and a pointer device can be considered, and other devices than these (e.g. a speaker, a microphone, and others) may also be permitted. Furthermore, as the substitute for the input/output device, the configuration where a serial interface is made an input/output device and a display computer comprising a display, a keyboard, or a pointer device is connected to the relevant interface may also be permitted. In this case, the display may also be performed on the display computer by transmitting the display information to the display computer and receiving the input information from the display computer, and the input and display in the input/output device may also be replaced by accepting the input.

Hereinafter, a set of one or more computers which manage the computer system and display the display information of the present invention might be referred to as a management system. The management terminal 124, if displaying the display information, is a management system. Furthermore, a combination of the management terminal 124 and the display computer is also a management system. Furthermore, for improving the speed and the reliability of the management processing, the processing equivalent to the management terminal 124 may also be realized by a plurality of computers, in which case, the relevant plurality of computers are referred to as a management system. Furthermore, the management terminal 124 is installed in the data center 120 in this embodiment, but may also be installed outside the data center 120 as an independent existence.

The network 105 is the site LAN in the site A 100, the network 115 is the site LAN in the site B 110, the network 125 is the data center LAN in the data center 120, the network 130 performs the network connection between the site A 100 and the data center 120 by WAN, and the network 140 performs the network connection between the site B 110 and the data center 120 by WAN. The type of network is not limited to the above networks, and various types of networks are available.

<Logical System Configuration>

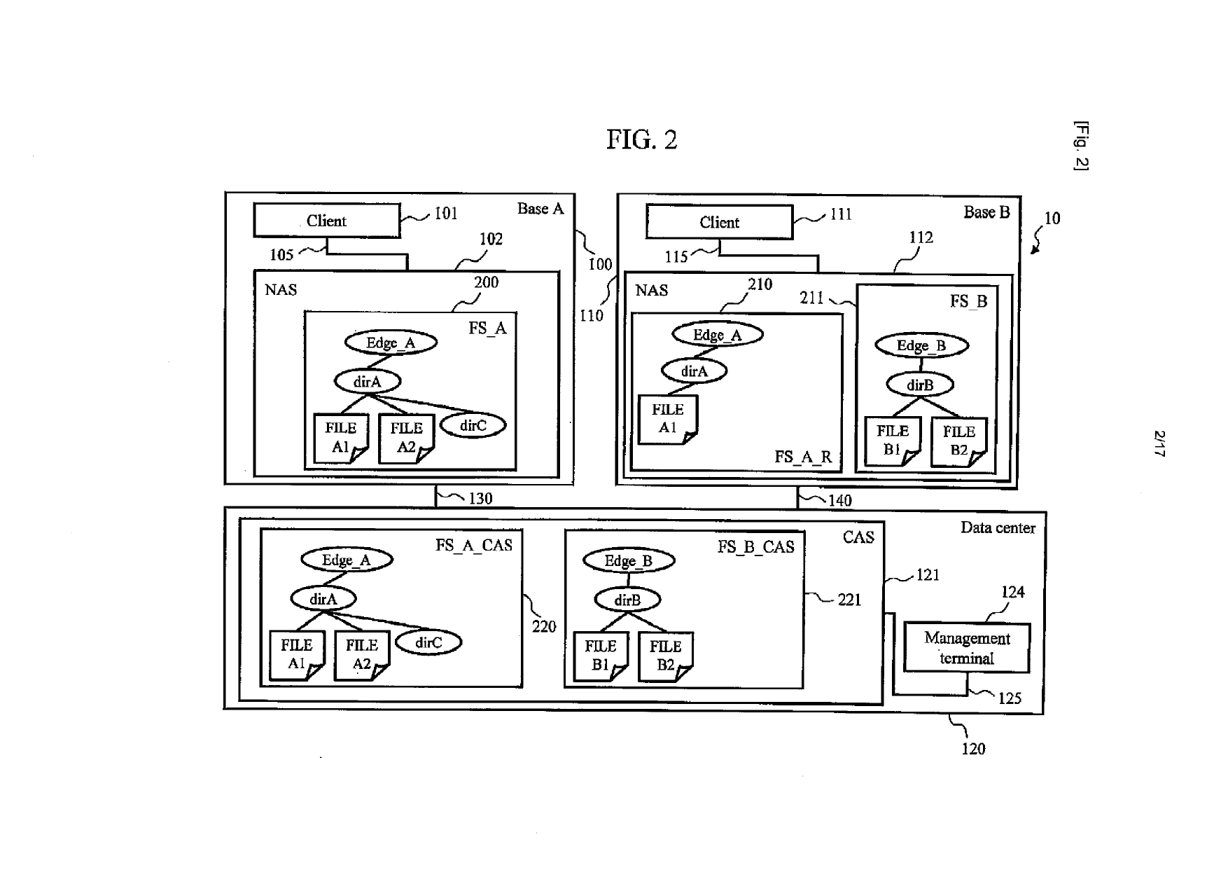

FIG. 2 is a block diagram showing an example of the logical configuration of the information processing system by the embodiment of the present invention. In the relevant information processing system 10, the data which the client 101 of the site A 100 reads and writes is stored as files in a file system FS_A200 which the NAS device 102 creates. As for the site B 110, similarly, the data which the client 111 reads and writes is stored as files in a file system FS_B211 which the NAS device 112 creates.

The files stored in the file system FS_A200 and the file system FS_B211 are archived or backed up to the data center 120 by a certain trigger (a specified or arbitrary timing: for example, batch processing at night). The file system FS_A_CAS220 which the CAS device 121 creates is a file system associated with the file system FS_A200 of the site A and, in the file system FS_A200, the file group which is archived or backed up is stored in the file system FS_A_CAS220. Similarly, the file system FS_B_CAS221 which the CAS device 121 creates is a file system associated with the file system FS_B211 of the site B and in the file system FS_B211, the file group which is archived or backed up is stored in the file system FS_B_CAS221.

The file system FS_A_R210 which the NAS device 112 in the site B 110 creates is a file system for the client 111 to refer to the files in the site A 100. The file system FS_A_R210 is associated with the file system FS_A_CAS220, and at least a part of the file system FS_A_CAS220 is stored in the file system FS_A_R210.

<System Processing Overview>

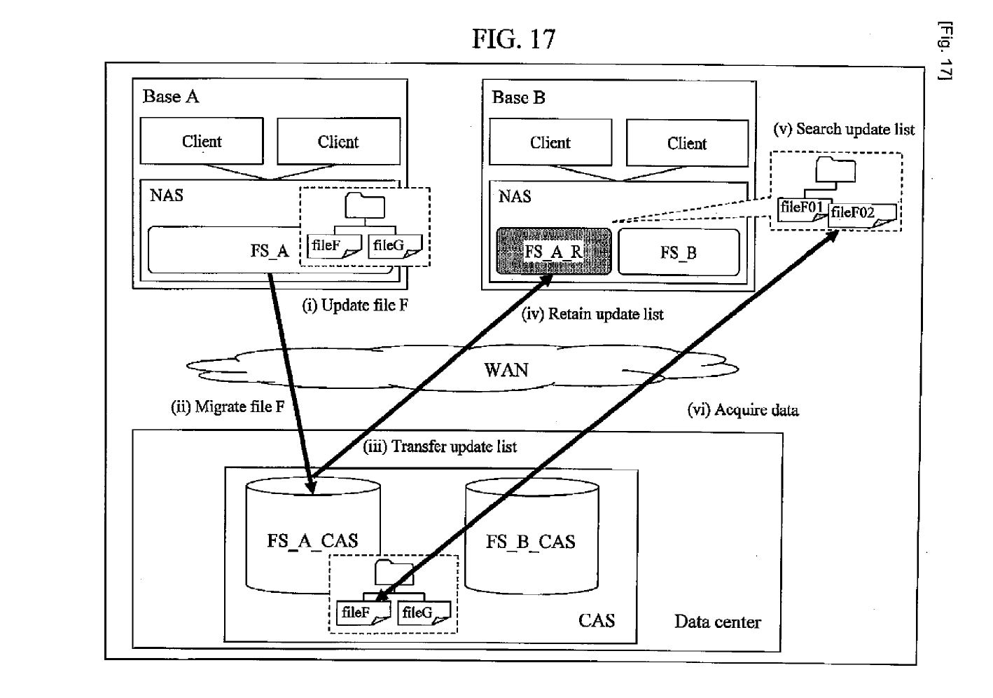

FIG. 17 is a diagram for explaining the characteristics of the processing overview in the Embodiment 1 of the present invention. In FIG. 17, for example, if a read request is made by the site B to a file of the site A which is already stored in the site B, the NAS device of the site B searches the remote site update list and determines whether the relevant file is updated or not. The processing procedure is as follows (from (i) to (vi) in FIG. 17).

Firstly, it is assumed that a file F is updated in the site A (processing (i)). It should be noted that the file F is assumed to be copied to the site B before the update processing in the site A (the file of the site A retained in the site B is referred to as a remote site file). Subsequently, the NAS device in the site A updates the file F in the data center (CAS device) by the migration processing (processing (ii)). Meanwhile, after the archiving processing, the data center creates an update list (update management information for notification) including the update information of the file F and transfers the same to the site B (processing (iii)). The NAS device in the site B retains the update list (the remote site update list: remote site update management information), and adds the file update information included in the transferred update list to the remote site update list (processing (iv)). Subsequently, in requiring read to the stored file, the NAS device in the site B searches the remote site update list and confirms whether a file as the target of read is updated or not (processing (v)). If the relevant file is updated (as the data which is currently retained is not valid), the NAS device in the site B reads the target file again from the data center (CAS device) and acquires the data or, if [the relevant file is] not updated, as it is unnecessary to read [the file] again (the retained data is valid), reads the file which is already retained (processing (vi)).

As explained above, by the Embodiment 1, the NAS device 112 retains the update file table 600 and, if the client 111 makes a read request to the file data, determines whether [the file] is valid or not by using the update file table 600, which can reduce the response time. The update file table 600 may be any one of a hash table, a DB, and file system metadata, or may also be a combination of the same.

The existing file which is already stored is not overwritten and is stored as a file which has the same path name but is of another version. For example, suffixes such as the version number, the update date, and others may also be added to the file name. Furthermore, the file attribute information may also include the version number, by whom the file was last updated, and others. By these methods, the previous files which are already stored become referable if the client 111 wants to refer to the same.

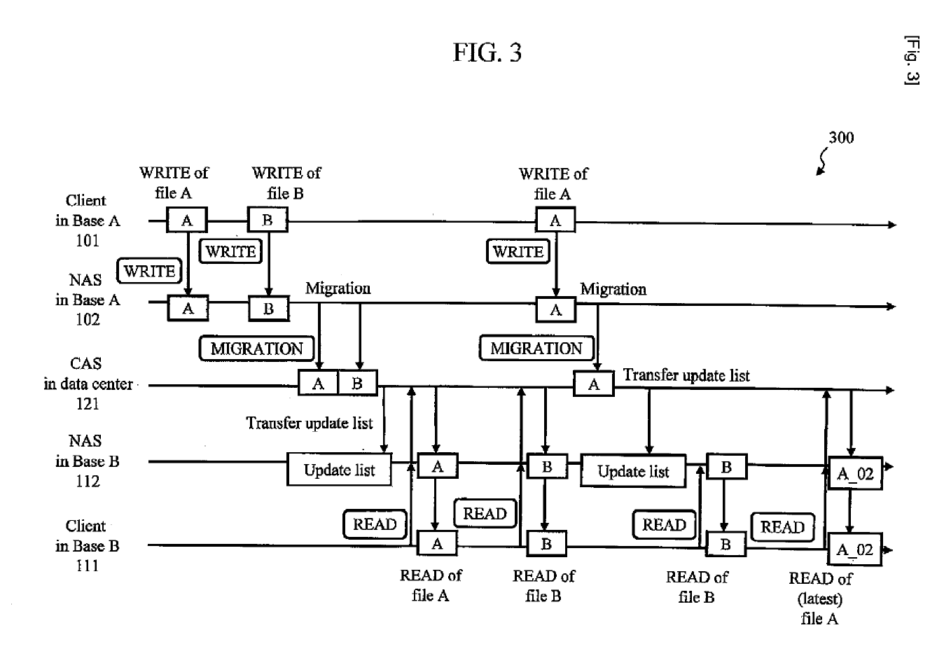

FIG. 3 is a diagram showing the frame format of the time chart of the migration processing, the file read processing, and others in the information processing system of this embodiment.

The client 101 in the site A 100 writes the file A and the file B to the NAS device 102. These files are transferred to the CAS device 121 by the migration processing of the NAS device 102 which is explained later.

The CAS device 121 creates an update list which lists the file group which is updated in the file system FS_A_CAS220 of the CAS device 121 by the migration processing, and transfers the same to the NAS device 112 of the site B 110. This update list includes the file A and the file B.

The NAS device 112 in the site B 110 receives the update list and creates an update list table 600. Subsequently, the client 111 in the site B 110 reads the file A and the file B. The NAS device 112 performs the file read processing which is explained later. At this step, as the NAS device 112 has not stored the file data of the file A and the file B in the file system FS_A_R210, [the NAS device 112] acquires the relevant file data from the CAS device 121 and stores the same in the file system FS_A_R210.

Subsequently, the file A is updated by the client 101, and the updated file is transferred to the CAS device 121 by the migration processing of the NAS device 102. After the file update processing in the CAS device 121 is performed, the file A is supposed to be included in the update list.

If the client 111 accesses the file B in this status, the NAS device 112 refers to the update list table 600 and determines whether the file data of the file B stored in the file system FS_A_R210 is valid (being the data of the same contents as the file B managed in the site A 100 or the data center 120) or not. As the file B is not updated since the last reference, the NAS device 112 returns the file B stored hi the file system FS_A_R210 to the client 111.

Meanwhile, as the file A is updated after the previous reference, the NAS device 112 determines that the file A is not valid, acquires the relevant file data from the CAS device 121, stores the acquired file data in the file system FS_A_R210, and returns the same to the client 111.

This makes it possible to determine in the site whether the file is valid or not and, if the access is for the file which is not updated, to reduce the communication between the site and the data center, which can shorten the response time.

<Internal Configuration of NAS Device>

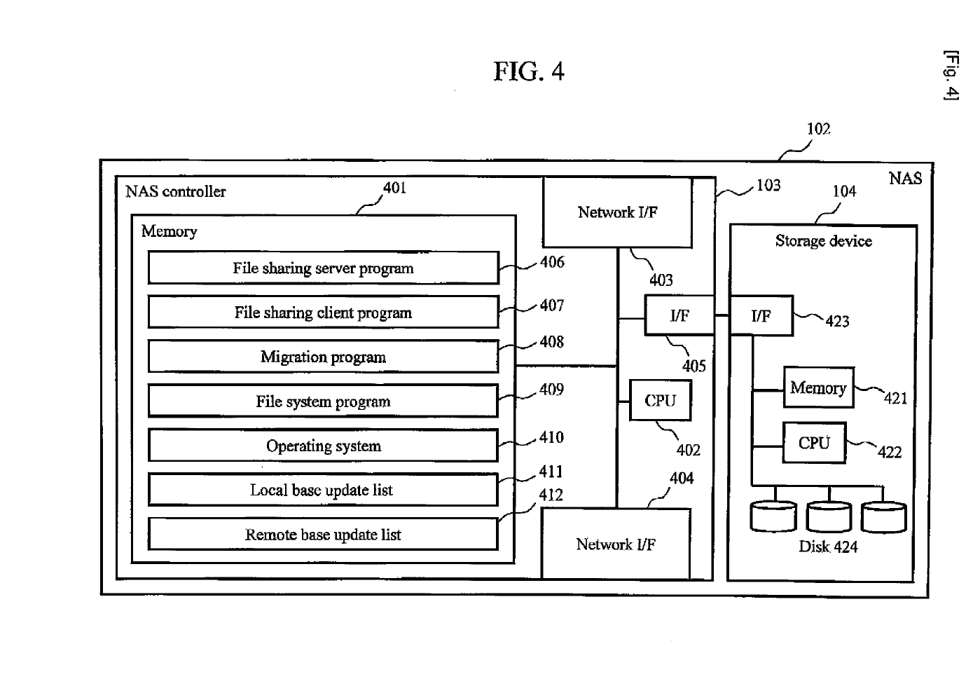

FIG. 4 is a block diagram showing an example of the internal configuration of the NAS device 102. While FIG. 4 shows the configuration of the NAS device 102 in the site A 100, the NAS device 112 in the site B 110 is in the same configuration.

The NAS device 102 comprises a NAS controller 103 and a storage device 104.

The NAS controller 103 comprises a CPU 402 for performing programs stored in a memory 401, a network interface 403 used for the communication with the client 101 via the network 105, a network interface 404 used for the communication with the data center 120 via the network 130, an interface 405 used for the connection with the storage device 104, and the memory 401 for storing the programs and data, which are connected by an internal communication path (e.g., a bus).

The memory 401 stores a file sharing server program 406, a file sharing client program 407, a migration program 408, a file system program 409, an operation system (OS) 410, a local site update list 411, and a remote site update list 412. It should be noted that the aspect on which the respective programs from 406 to 410 and the respective update lists 411 and 412 stored in the memory may also be stored in the storage device 104, read by the CPU 402 to the memory 401 and performed may also be permitted.

The file sharing server program 406 is a program which provides a means for the client 101 to perform file operations for the files in the NAS device 102. The file sharing client program 407 is a program which provides a means for the NAS device 102 to perform file operations for the files in the CAS device 121, and the file sharing client program 407 makes it possible for the NAS device of each of the sites to perform specified file operations for the files in the local site and the remote sites in the CAS device 121. The migration program 408 performs the file migration from the NAS device 102 to the CAS device 121. The file system program 409 controls the file system FS_A200.

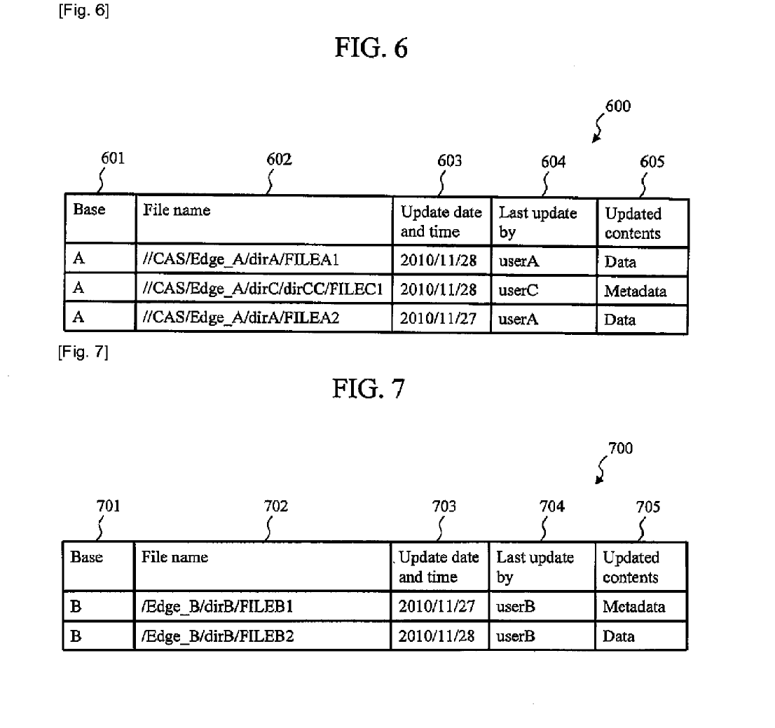

The local site update list 411 is a list for managing the update information of the files which the NAS device 102 manages locally. Furthermore, the remote site update list 412 is a list for managing the update information of the files acquired from the CAS device 121 which the NAS devices in the remote sites manage. The details of the local site update list 411 and the remote site update list 412 are explained with reference to FIG. 6 and FIG. 7.

The storage device 104 comprises an interface 423 used for the connection with the NAS controller 103, a CPU 422 which performs instructions from the NAS controller 103, a memory 421 for storing the programs and data, and one or a plurality of disks 424, which are connected by an internal communication path (e.g. a bus). The storage device 104 provides a storage function in units of blocks such as FC-SAN (Fibre Channel Storage Area Network) to the NAS controller 103.

<Internal Configuration of CAS Device>

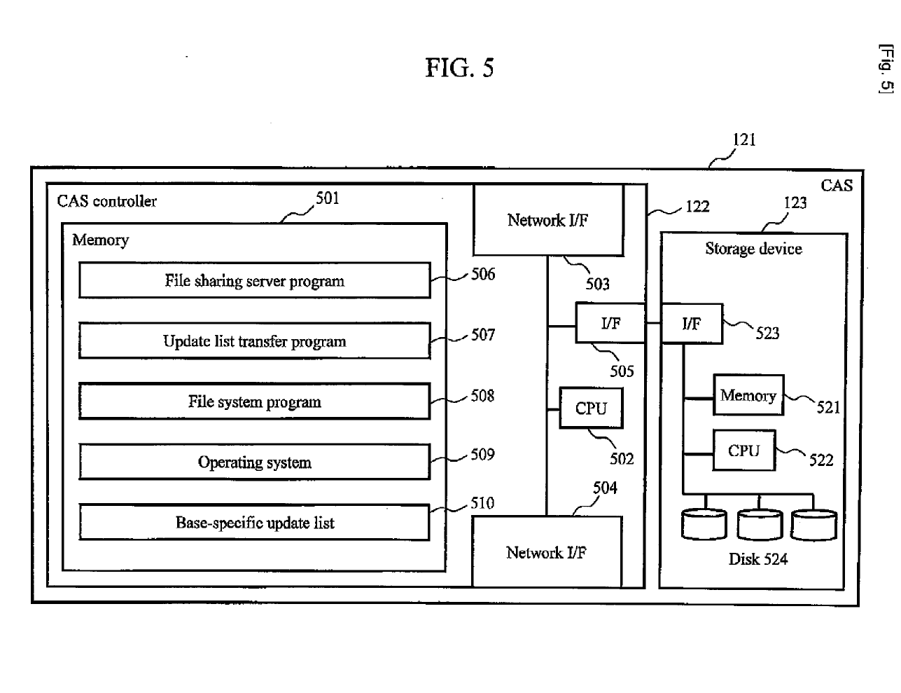

FIG. 5 is a block diagram showing an example of the internal configuration of the CAS device 121. The CAS device 121 comprises a CAS controller 122 and a storage device 123.

The CAS controller 122 comprises a CPU 502 for performing programs stored in a memory 501, a network interface 503 used for the communication with the NAS devices 102 and 112 via the networks 130 and 140, a network interface 504 used for the communication with the management terminal 124 via the network 125, an interface 505 used for the connection with the storage device 123, and the memory 501 for storing the programs and data which are connected by an internal communication path (e.g. a bus).

The memory 501 stores a file sharing server program 506, an update list transfer program 507, a file system program 508, an operation system 509, and a site-specific update list 510. It should be noted that the aspect on which the respective programs from 506 to 509 and the site-specific update list 510 may also be stored in the storage device 123, read by the CPU 502 to the memory 501 and performed may also be permitted.

The file sharing server program 506 is a program which provides a means for the NAS devices 102 and 112 to perform file operations for the files in the CAS device 121. The update list transfer program 507 is a program which transfers the update list 600 to the NAS device 112. The file system program 508 controls the file systems FS_A_CAS220 and FS_B_CAS221.

The storage device 123 comprises an interface 523 used for the connection with the CAS controller 122, a CPU 522 which performs instructions from the CAS controller 122, a memory 521 for storing the programs and data, and one or a plurality of disks 524, which are connected by an internal communication path (e.g. a bus). The storage device 123 provides a storage function in units of blocks such as FC-SAN (Fibre Channel Storage Area Network) to the CAS controller 122.

<Remote Site Update List>

FIG. 6 is a diagram showing a configuration example of the remote site update list table (the update information of the site A in this embodiment) in the NAS device 112 in the site B. It should be noted that the remote site (site A) also comprises a similar remote site update list table related to the remote site (the site B as seen from the site A).

The remote site update list table 600 (referred to as a remote site update list 412 in FIG. 4) comprises a site name 601, a file name 602, an update date and time 603, a last update by 604, and updated contents 605 as components.

The site name 601 is the information indicating which site the data and files to which the update information is related is in, and the site name and the identification information [of the site] other than the local site (site B) are described. The file name 602 is the information for identifying the file related to the update (the identification information for identifying the file such as a path). The update date and time 603 is the information indicating the date and time when the corresponding file is updated. The last update by 604 is the information indicating the user identification that last updated the corresponding file (which is not limited to a name and an identification code and others may also be permitted). The updated contents 605 are the information indicating whether the updated contents are data or metadata. At this step, the metadata includes a user ID, permission, a file size, a file attribute, owner change information, and others.

This type of remote site update list table makes it possible to know the file update status in the remote sites.

<Local Site Update List>

FIG. 7 is a diagram showing a configuration example of the local site update list table (the update information of the local site B in this embodiment) in the NAS device 112 in the site B. It should be noted that the remote site (site A) also comprises a similar local site update list table related to the local site (the local site A).

The local site update list table 700 (referred to as a local site update list 411 in FIG. 4) comprises a site name 701, a file name 702, an update date and time 703, a last update by 704, and updated contents 705 as components.

The site name 701 is the information indicating in which site the update is performed, and the name or the identification information of the local site is described. The file name 702 is the information for identifying the file related to the update (the identification information for identifying the file such as a path). The update date and time 703 is the information indicating the date and time when the corresponding file is updated. The last update by 704 is the information indicating the user identification that last updated the corresponding file (which is not limited to a name and an identification code and others may also be permitted). The updated contents 705 are the information indicating whether the updated contents are data or metadata. At this step, the metadata includes a user ID, permission, a file size, a file attribute, owner change information, and others.

The local site update list table 700 is created and updated by the NAS device 112 each time the migration processing [is performed]. Specifically speaking, the local site update list table 700 is a list of path names of the files which are updated between the N-th time of migration processing and the N+1-th time of migration processing. In addition to the path names, the metadata of the relevant files such as owners, whom [the files are] last updated by, and the last update dates and time may also be combined with the path names and recorded.

This type of local site update list table makes it possible to manage the file update status in the local site and notify the information of the file update status to the CAS device 121 and the NAS devices in the remote sites.

<Site-Specific Update List>

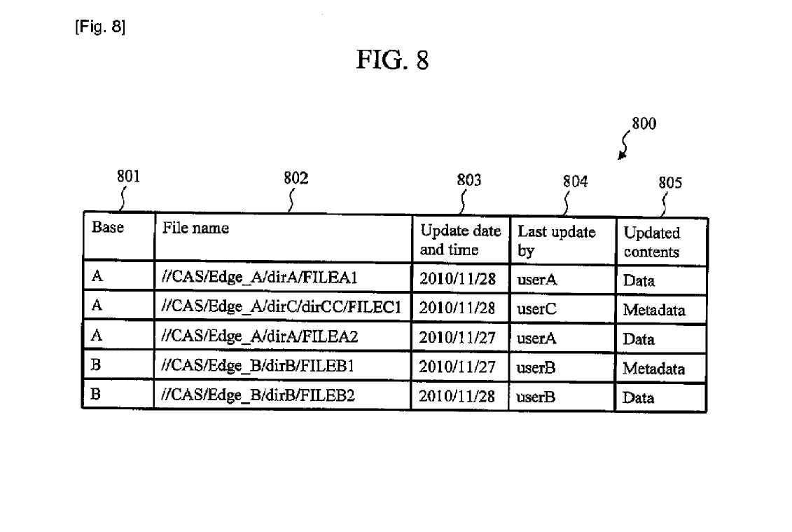

FIG. 8 is the information showing a configuration example of the site-specific update list which the CAS device 121 comprises. Though the update information of all the sites are supposed to be managed by one table in the example of FIG. 8, it may also be permitted to manage each piece of the update information by using a plurality of site-specific tables.

The site-specific update list table 800 (referred to as a site-specific update list 510 in FIG. 5), as the other update lists, comprises a site name 801, a file name 802, an update date and time 803, a last update by 804, and updated contents 805 as components.

The site name 801 is the information indicating which site the data and files to which the update information is related is in. The file name 802 is the information for identifying the file related to updates (the identification information for identifying the file such as a path). The update date and time 803 is the information indicating the date and time when the corresponding file is updated. The last update by 804 is the information indicating the user identification that last updated the corresponding file (which is not limited to a name and an identification code and others may also be permitted). The updated contents 805 are the information indicating whether the updated contents are data or metadata. At this step, the metadata includes a user ID, permission, a file size, a file attribute, owner change information, and others.

This type of site-specific update list table makes it possible to manage the update status of data and files in each of the sites.

It should be noted that, though the updated contents are retained in table form as shown in Figures from 6 to 8, other forms may also be permitted. For example, a hash table or a DB form may also be permitted for speeding up the search. It may also be permitted to create a flag for each of the files indicating the file is updated and retain the same as metadata in the file system FS_A_R210.

<File Read Processing>

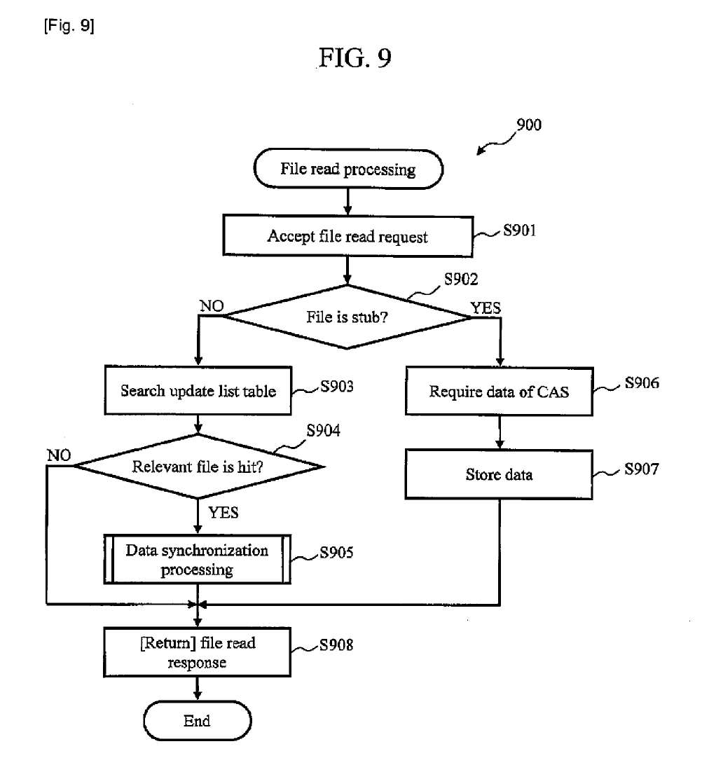

FIG. 9 is a flowchart for explaining the file read processing for the file system FS_A_R210 in the site B 110 by the present invention. The file read processing is called when the client 111 makes a file read request. Hereinafter, the processing shown in FIG. 9 is explained in order of the numbers of the steps.

Step S901: The file system program 409 in the NAS device 112 receives a file read request from the client 111 via the file sharing server program 406.

Step S902: The file system program 409 in the NAS device 112 determines whether the file for which the read request is made is a stub or not. If the file for which the read request is made is not a stub (in case of NO at the step S902), the processing proceeds to the step S903. Meanwhile, if the file for which the read request is made is a stub (in case of YES at the step S902), the processing proceeds to the step S906. This is because, if a certain period of time elapses, the data might be deleted and the file might be replaced by stub information. Specifically speaking, even the file in a remote site instead of the file in the local site is replaced by stub information if [the file is] not used for a certain period of time.

Step S903: The file system program 409 in the NAS device 112 searches the remote site update list table 600 and determines whether the relevant file is valid or not. Specifically speaking, it is determined whether the file of the remote site retained by the NAS device 112 is updated or not. This is because, if [the file is] updated (if [the file is] in the remote site update list), the contents of the updated relevant file are different from the contents of the file of the remote site which the NAS device 112 comprises, and therefore the contents must be synchronized.

Step S904: If the entry of the relevant file is not in the remote site update list table 600 (in case of NO at the step S904), the processing proceeds to the step S908. In this case, as the file in the local site is the latest, the relevant file is supposed to be read as usual.

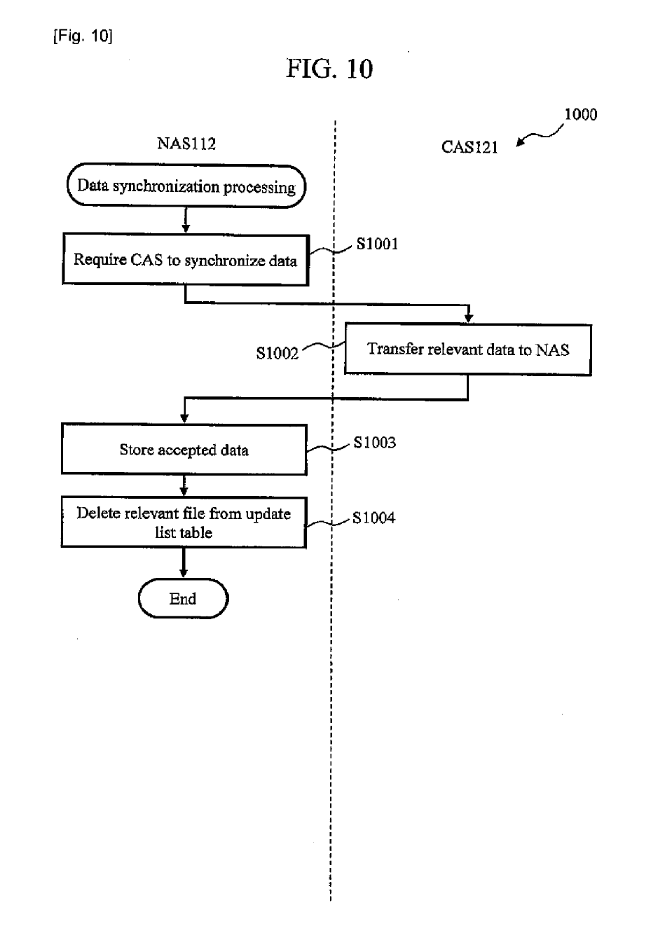

Step S905: Meanwhile, if the entry of the relevant file is in the remote site update list table 600 (in case of YES at the step S904), the data synchronization processing which is explained later in FIG. 10 is performed.

Step S906: If the file for which the read request is made is a stub (in case of NO at the step S902), the file sharing client program 407 in the NAS device 112 requires the data of the relevant file of the CAS device 121.

Step S907: The file sharing client program 407 in the NAS device 112 receives the data from the CAS device 121 and stores the data in the relevant file.

Step S908: The file system program 409 in the NAS device 112 returns the response of the file read to the client 111 via the file sharing server program 406.

In FIG. 9, the validity of the relevant file is determined at the step S904 by whether the entry of the relevant file is in the remote site update list table 600 or not. In addition to this aspect, even if the entry of the relevant file is in the remote site update list table 600, the validity may also be determined by using, for example, the update date and time 603 of the relevant entry and the attribute information of the file which is already stored in the file system FS_A_R210 such as the last update date and time.

<Details of Data Synchronization Processing>

FIG. 10 is a flowchart for explaining the details of the data synchronization processing. The data synchronization processing is the processing at the step S905 in FIG. 9, where the data synchronization is performed between the NAS device 112 and the CAS device 121. Hereinafter, the processing shown in FIG. 10 is explained in order of the numbers of the steps.

Step S1001: The file sharing client program 407 in the NAS device 112 transmits a data synchronization request of the relevant file to the CAS device 121.

Step S1002: The file system program 508 in the CAS device 121 receives the data synchronization request from the NAS device 112 via the file sharing server program 506, and transfers the data of the relevant file to the NAS device 112. The data to be transferred may be the entire data of the file and may also be the differential data between the file before the update and the file after the update. For enabling the transfer of the differential data, the information indicating in what part of the file the data is updated should be managed in the update list which the CAS device 121 comprises. Furthermore, the CAS device 121 must manage when the data of the remote site A which the site B comprises is read by the site B. For this reason, by the NAS device 112 in the site B transmitting the update date and time information which the NAS device 112 manages to the CAS device 121, the CAS device 121 can ascertain what point of time of updated file is the target of the differential data which should be transferred to the site B.

Step S1003: The file sharing client program 407 in the NAS device 112 receives the data of the relevant file from the CAS device 121 and stores the received data in the local file system FS_A_R210 in collaboration with the file system program 409.

Step S1004: The file system program 409 in the NAS device 112 deletes the entry of the relevant file from the remote site update list table 600.

It should be noted that, in the processing at the step S1003, the NAS device 112 does not overwrite the existing file which is already stored and stores the same as a file which has the same path name but is of another version. For example, suffixes such as the version number and the update date may also be added to the file name. Furthermore, the file attribute information may also include the version number, by whom the file was last updated, and others. These methods make the previous files which are already stored referable if the client 111 wants to refer to the same.

<File Write Processing>

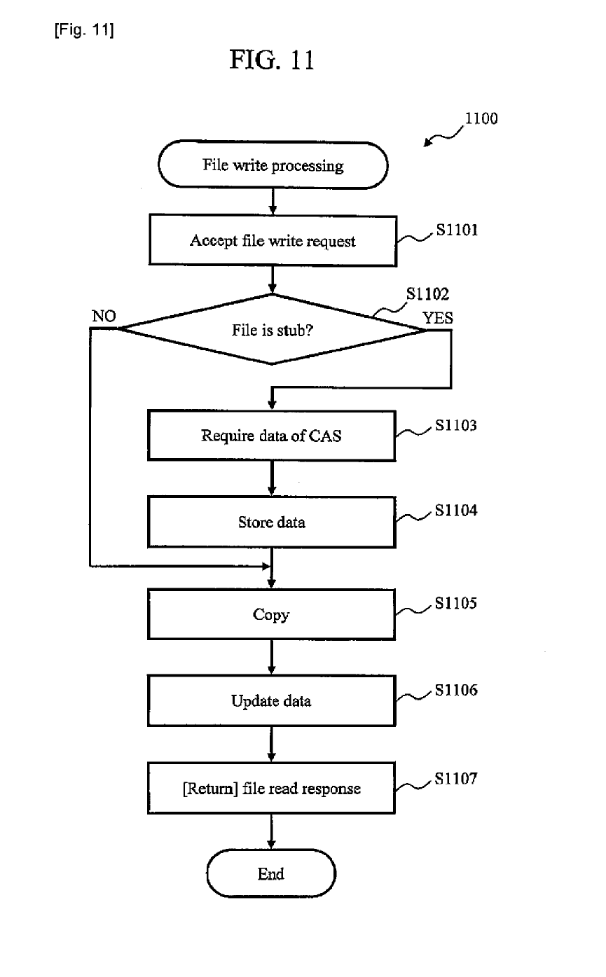

FIG. 11 is a flowchart for explaining the file write processing for the file system FS_A_R210 in the site B 110. In this embodiment, the file system FS_A_R210 which refers to the files in the remote site realizes file write by copying the relevant file to the local file system FS_B211 which can be updated and subsequently writing [the data] to the file because the file update from the client 111 in the site B is forbidden. Hereinafter, the processing shown in FIG. 11 is explained in order of the numbers of the steps.

Step S1101: The file system program 409 in the NAS device 112 accepts a file write request from the client 111 via the file sharing server program 406.

Step S1102: The file system program 409 in the NAS device 112 determines whether the relevant file is a stub or not. If the relevant file is not a stub (in case of NO at the step S1102), the processing proceeds to the step S1205.

Step S1103: Meanwhile, if the relevant file is a stub (in case of YES at the step S1102), the file sharing client program 407 in the NAS device 112 requires the data of the CAS device 121.

Step S1104: The file system program 409 in the NAS device 112 receives the data required from the CAS device 121 via the file sharing client program 407 and stores the same in the file system FS_A_R210.

Step S1105: The file system program 409 in the NAS device 112 copies the relevant file from the file system FS_A_R210 to the file system FS_B211. Since the user of the site B tries to update the file in the original site A, it is ensured that the update processing can be performed for the copied file and that the original file can be retained as is.

Step S1106: The file system program 409 in the NAS device 112 updates the data for the copied file in the file system FS_B211.

Step S1107: The file system program 409 in the NAS device 112 returns the response of the file write to the client 111 via the file sharing server program 406.

<Data Deletion Processing>

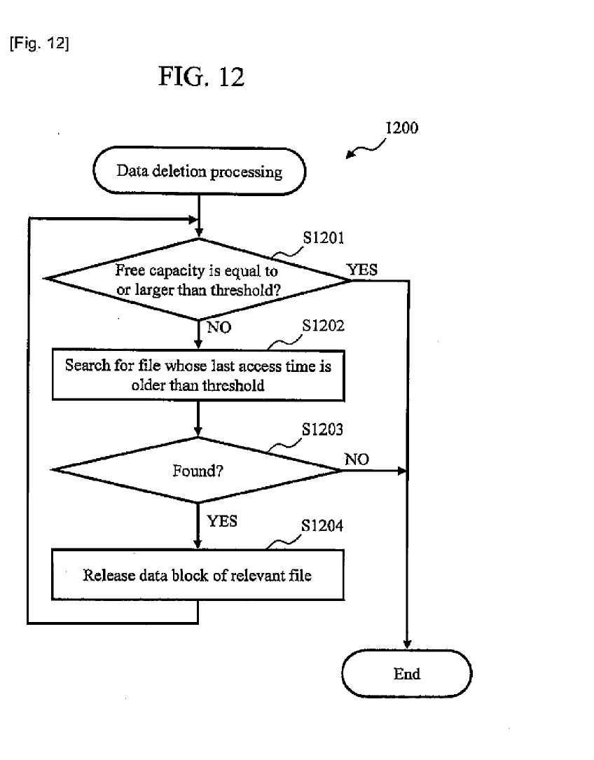

FIG. 12 is a flowchart for explaining the data deletion processing. The data deletion processing is regularly called by the OS 410 in the NAS device 102, and releases the data blocks of the file whose last access time is older than the threshold in the file system FS-A200. While FIG. 12 explains the site A 100, [the processing is] the same in the file systems FS_A_R210 and FS_B211 in the site B 110. Hereinafter, the processing shown in FIG. 12 is explained in order of the numbers of the steps.

Step S1201: The file system program 409 in the NAS device 102 determines whether the free capacity of the file system FS_A200 is equal to or larger than a threshold or not. If the free capacity of the file system FS_A200 is equal to or larger than the threshold (in case of YES at the step S1201), the data deletion processing is terminated. The threshold can be appropriately specified from the management terminal 124 by the system administrator or by the user of the client 101.

Step S1202: Meanwhile, if the free capacity of the file system FS_A200 is below the threshold (in case of NO at the step S1201), the file system program 409 in the NAS device 102 searches a file whose last access time is older than a threshold, in the file system FS_A200. This threshold can also be specified appropriately from the remote [component] by the system administrator or specified appropriately by the user of the client 101.

Step S1203: If no file whose last access time is older than the threshold can be found as a result of the step S1202 (in case of NO at the step S1203), the data deletion processing is terminated.

Step S1204: Meanwhile, if a file whose last update time is older than the threshold is found (in case of YES at the step S1203), the file system program 409 in the NAS device 102 releases the data blocks of the relevant file. Subsequently, the processing proceeds to the step S1201.

It should be noted that, though the last access time is specified as the condition for the data deletion processing in FIG. 12, the attribute information such as the last update date and time and the size or a combination of the same may also be adopted.

Furthermore, at the step S1203, an alert related to the capacity (free capacity) of the NAS device 102 may also be displayed for the management terminal 124 and the user of the client 101. The data deletion processing may also be continued by automatically decreasing the threshold (easing the condition) and searching [a relevant file] again.

Furthermore, though the NAS device 102 releases the data blocks of the relevant file, that is, stubs the relevant file at the step S1204, the relevant file may also be deleted including the stub information.

<Migration Processing>

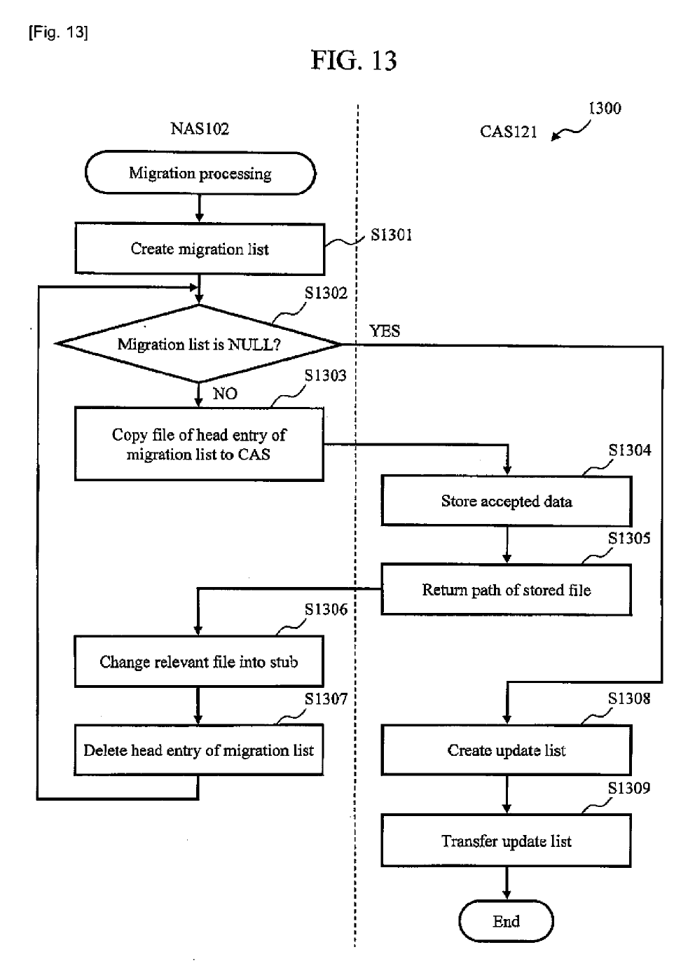

FIG. 13 is a flowchart for explaining the migration processing by the NAS device 102 in the site A 100. The migration processing is called from the OS 410 in a cycle/at a timing of migration set by the administrator and is the processing of transferring (archiving or backing up) the files satisfying the migration condition set by the administrator explained later among the files which are stored in the NAS device 102 to the CAS device 121. While FIG. 13 explains the migration processing in the site A 100, the processing is performed similarly in the file system FS_B211 in the site B 110. Furthermore, in FIG. 13, since the processing of changing [the file] into stub information is included at S1306, the case where [the file is] archived to the CAS 121 is explained. In case of the backup processing, since the file remains in the site, the deletion processing may also be performed after a specified period of time elapses since the backup processing. Hereinafter, the processing shown in FIG. 13 is explained in order of the numbers of the steps.

Step S1301: The migration program 408 in the NAS device 102 searches the files stored in the file system FS_A200 and creates a migration list. The migration list includes the entry of the file satisfying the migration condition set by the administrator.

Step S1302: The migration program 408 in the NAS device 102 determines whether the migration list is NULL or not. If the migration list is NULL (in case of YES at the step S1302), the NAS device 102 transmits a migration processing completion notification to the CAS device 121, and shifts the processing to the step S1308.

Step S1303: Meanwhile, if the migration list is not NULL (in case of NO at the step S1302), the migration program 408 in the NAS device 102 copies the file of the head entry in the migration list to the CAS device 121 via the file sharing client program 407.

Step S1304: The file system program 508 in the CAS device 121 stores the file received from the NAS device 102 in the file system FS_A_CAS220 via the file sharing server program 506.

Step S1305: The file system program 508 in the CAS device 121 returns the path of the stored file to the NAS device 102 via the file sharing server program 506.

Step S1306: The migration program 408 in the NAS device 102 changes the relevant file to a stub. At this step, [the program 408] includes the file path returned from the CAS device 121 at the step S1305 in the stub. The file is replaced by the stub information as explained above only in the case of the archiving processing in the migration processing. In case of the backup processing in the migration processing, the file is not replaced by the stub information, and the relevant file is retained as is in the NAS device 102.

Step S1307: The migration program 408 in the NAS device 102 deletes the head entry in the migration list. Subsequently, the processing proceeds to the step S1302.

Step S1308: The file system program 508 in the CAS device 121 receives the migration processing completion notification from the NAS device 102, and creates an update list as a list of the file group updated by the migration processing.

Step S1309: The file system program 508 in the CAS device 121 transfers the update list created at the step S1308 to the NAS device 112 in the site B 110.

Though the migration processing is called from the OS 410 in a cycle/at a timing of migration set by the administrator in this embodiment, the migration processing for the file may also be performed at the timing when the file satisfying the migration condition is found.

Furthermore, though the NAS device 102 creates the migration list at the step S1301 in FIG. 13, the timing for creating the migration list is not limited to this. Specifically speaking, though the migration list is supposed to be created when the migration processing is called in FIG. 13, it may also be permitted that the file name is added to the migration list appropriately each time the file is updated.

As the migration conditions set by the administrator, for example, the owner of the file, the creation date and time of the file, the last update date and time of the file, the last access date and time of the file, the file size, the file type, whether WORM (Write Once Read Many) is set or not, whether retention is set or not and how long, and others, are set as AND/OR conditions. The migration conditions may also be set for the entire file system FS_A200 or may also be set for a specific directory or file individually.

It should be noted that the file which is once archived, recalled (restored), and stored in the file system FS_A200 becomes the target of the migration processing again if the relevant file data is updated. In this case, as the method for the NAS device 102 to determine whether the recalled file is updated or not, the methods below can be named. For example, the management may be performed by using the flag storing “whether there is any write after the recall or not” as the attribute information of the file. Furthermore, the method may also be that the field storing a “recall date and time” is set as the attribute information of the file and that [whether the file is updated or not is] determined by comparing the same with the last update date and time. Furthermore, the method may also be that, if a write request is made for the recalled file, the migration processing is performed at the timing when the response to the write request is terminated.

Furthermore, though FIG. 13 shows the example in which the migration is performed starting with the file of the head entry in the migration list in the migration processing, the similar processing can be performed even if the migration is performed starting with the file of the last entry in the migration list.

In the embodiment of the present invention, creation of the migration list by the NAS device 102 at the step S1301 may also be replaced by the creation of the update list. Furthermore, in the migration list which the NAS device 102 creates at the step S1301, the file group for which the migration processing is successful may be supposed to be the update list. In these cases, the transfer of the update list may be realized by the NAS device 102 transferring the update list to the CAS device 121 and furthermore by the CAS device 121 transferring the update list to the NAS device 112.

Furthermore, though the CAS device 121 transfers the update list to the NAS device 112 at the step S1309 in FIG. 13, the timing for transferring the update list is not limited to this. For example, it may also be permitted that the CAS device 121 notifies the completion of the migration processing to the NAS device 112, and subsequently, the NAS device 112 requires the CAS device 121 to transfer the update list.

Though a list of file groups updated by the migration processing are supposed to be the local site/remote site update lists in the embodiment of the present invention, the files stored in the update list are not limited to this. For example, it may also be permitted that the NAS device 112 notifies a list of the files of the remote site which are locally stored to the CAS device 121, that the CAS device 121 extracts the files in the remote site which are already stored in the NAS device 112 in the file group updated by the migration processing, and that these [files] are supposed to be the update information configuring the remote site update list. By this method, the size of the update information configuring the remote site update list can be reduced and the amount of the transferred data can be reduced. Furthermore, in storing the updated file to the remote site update list table 600, the NAS device 112 may also add only the entry of the file of the remote site which is stored in the NAS device 112 to the remote site update list table 600. By this method, the size of the remote site update list table 600 can be reduced.

As explained above, in the Embodiment 1, the NAS device 112 retains the remote site update list table 600 and, if the client 111 makes a read request for the file data, determines whether the file is valid or not (whether the file of the remote site retained in the local site is consistent with the file retained in the remote site) by using the remote site update list table 600. By this method, the necessity of the file synchronization processing can be determined, and the response time can be reduced.

### (2) Embodiment 2

Hereinafter, the Embodiment 2 of the present invention is explained. It should be noted that the differences from the Embodiment 1 are mainly explained below, and the explanation of what is common to the Embodiment 1 is omitted or simplified.

In the Embodiment 1 of the present invention, after receiving the update list in the remote site (site A) notified from the CAS device 121 (it may also be permitted that the update information is acquired directly from the NAS device in the remote site), the NAS device 112 adds the entry (entries) of the file (group) of the remote site retained in the local site to the remote site update list table 600. Furthermore, the timing for the data synchronization processing is supposed to be when the client 111 makes a read request for the relevant file data.

Meanwhile, in the Embodiment 2 of the present invention, after the NAS device 112 receives the update list of the remote site, the data synchronization processing for the file (group) of the remote site retained in the local site is supposed to be performed collectively.

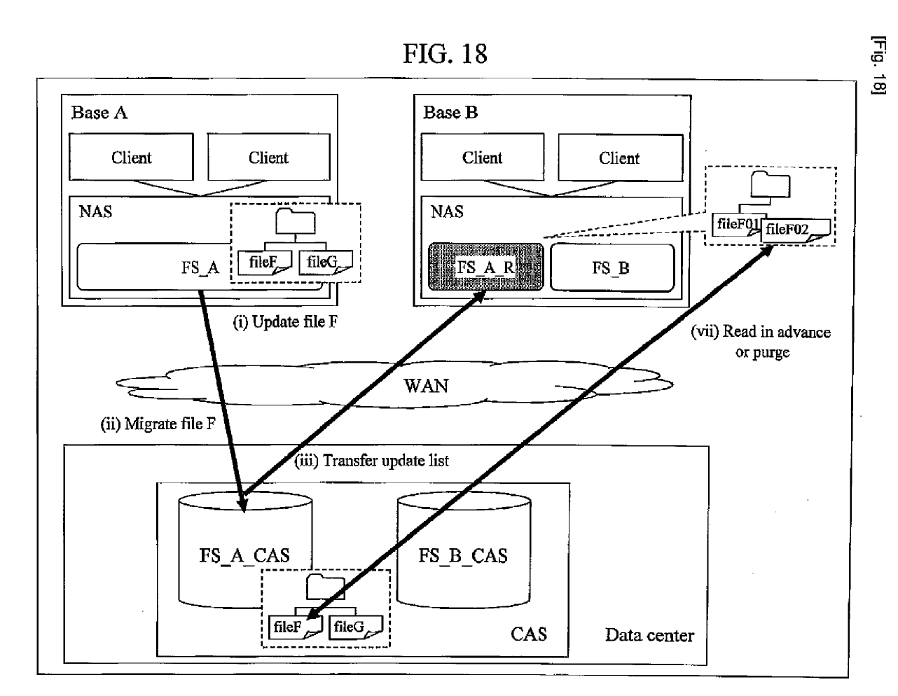

FIG. 18 is a diagram for explaining the characteristics of the processing overview in the Embodiment 2 of the present invention. In the Embodiment 2, after receiving the update list in the site B from the data center, the synchronization processing for the relevant file is performed. As for the procedure of the processing, after the processing from (i) to (iii) in the Embodiment 1 is performed, the processing (vii) is performed. Specifically speaking, the NAS device in the site B reads the latest data of the file corresponding to the update list transferred from the CAS device among the stored files which the site B already retains from the CAS device in advance or purges the same (processing (vii)).

As explained above, in the Embodiment 2, after the NAS device 112 receives the update list, the data synchronization processing for the file group registered in the update list is performed collectively. The Embodiment 2 and the Embodiment 1 may also be combined. For example, it may also be permitted that a part of the files are stored in the update list table 600, for which the data synchronization processing of the Embodiment 1 is performed, while the batched processing of data synchronization of the Embodiment 2 is performed for a part of the files when the update list is received. By storing the data which is updated in advance in the NAS device 112, the response time can be reduced.

<Batched Processing of Data Synchronization>

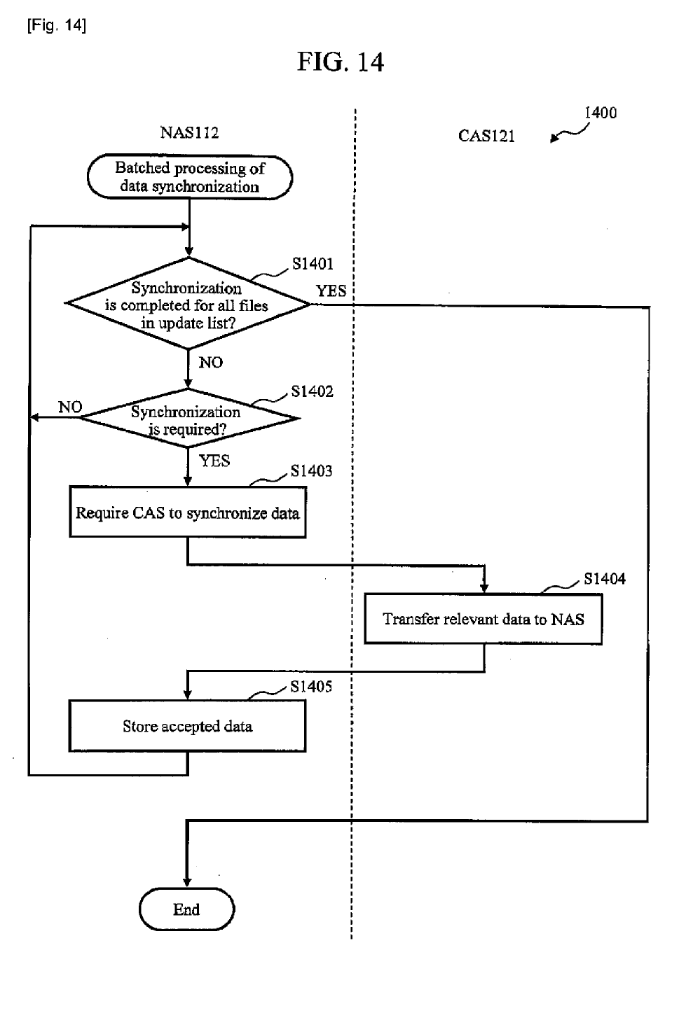

FIG. 14 is a flowchart for explaining the batched processing of data synchronization by the Embodiment 2. The batched processing of data synchronization is called after the NAS device 112 receives the update list from the CAS device 121. Hereinafter, the processing shown in FIG. 14 is explained in order of the numbers of the steps.

Step S1401: The file system program 409 in the NAS device 112 in the site B checks whether the synchronization processing is completed for all the files in the update list or not. If the synchronization processing is completed for all the files in the update list (in case of YES at the step S1401), the file system program 409 in the NAS device 112 completes the batched processing of data synchronization.

Step S1402: Meanwhile, if the synchronization processing is not completed for all the files in the update list (in case of NO at the step S1401), the file system program 407 in the NAS device 112 determines whether synchronization for the relevant file(s) is necessary or not. If synchronization is not necessary (in case of NO at the step S1402), the processing proceeds to the step S1401. It should be noted that the case where synchronization is not necessary includes the status where the relevant file is a stub in the NAS device 112 or the status where the file does not exist. This is because, if [the file is] a stub, the entity of the file is in the CAS device 121, from which the contents of the updated file is consistently acquired, and therefore it is not necessary to perform the synchronization processing point by point.

Step S1403: Meanwhile, if synchronization for the relevant file is necessary (in case of YES at the step S1402), the file system program 409 in the NAS device 112 requires the CAS device 121 to synchronize the data of the relevant file via the file sharing client program 407.

Step S1404: The file system program 508 in the CAS device 121 accepts the data synchronization request from the NAS device 112 via the file sharing server program 506, and transfers the relevant file data to the NAS device 112.

Step S1405: The file system program 409 in the NAS device 112 receives the data required from the CAS device 121 via the file sharing client program 407, and stores the same in the file system FS_A_R210.

It should be noted that it may also be permitted at the step S1405 in FIG. 14 that the NAS device 112 does not overwrite the existing file which is already stored and stores the same as a file which has the same path name but is of another version. For example, suffixes such as the version number and the update date may also be added to the file name. Furthermore, the file attribute information may also include the version number, by whom the file was last updated, and others. By these methods, the previous files which are already stored become referable if the client 111 wants to refer to the same.

Furthermore, though the NAS device 112 requires the CAS device 121 to synchronize the data of the relevant file in the processing at the step S1403, it may also be permitted to delete the file data which is already stored and change the same into a stub.

Though the batched processing of data synchronization is performed for all the files registered in the update list in FIG. 14, a combination with the Embodiment 1 may also be permitted. For example, it may also be permitted that a part of the files are stored in the remote site update list table 600, for which the data synchronization processing of the Embodiment 1 is performed, while the batched processing of data synchronization shown in FIG. 14 is performed for a part of the files. As [the processing] takes considerable time if the size of the data which is the target of the batched processing of data synchronization is large, separated synchronization can promote the efficient processing.

As explained above, in the Embodiment 2, response time can be reduced by the NAS device 112 performing the data synchronization processing before data requests from the client 111 and storing the data which is updated in advance in the NAS device 112.

### (3) Embodiment 3

Hereinafter, the Embodiment 3 of the present invention is explained. It should be noted that the differences from the Embodiment 1 and the Embodiment 2 are mainly explained below, and the explanation of what is common to the Embodiment 1 and the Embodiment 2 is omitted or simplified.

In the Embodiment 3 of the present invention, the file updated by the NAS device 102 is immediately archived or backed up to the CAS device 121, the CAS device 121 transfers the relevant file to the NAS device 112, and the NAS device 112 immediately updates the relevant file.

In the Embodiment 3, all the versions of the relevant file of the site A are made referable in the site B. This is achieved by the real-time synchronization processing explained later. Hereinafter, the processing procedure by the Embodiment 3 is explained. Each time a file F is updated in the site A, the update data is transferred to the data center in real time.

Subsequently, the data center notifies the update to the site B each time the file F is updated. Meanwhile, the NAS device in the site B acquires the latest data from the data center each time the update of the file F is notified. If the data center manages the file versions, it may also be permitted to acquire unacquired versions collectively at certain timing. Furthermore, the system may also operate so that only the user specified files may be supported (as the batched migration processing at night is basically assumed).

As explained above, in the Embodiment 3, real-time file sharing among sites is realized by immediately archiving or backing up the file updated by the NAS device 102 to the CAS device 121, the CAS device 121 transferring the relevant file to the NAS device 112, and the NAS device 112 updating the relevant file immediately.

<Original File Write Processing>

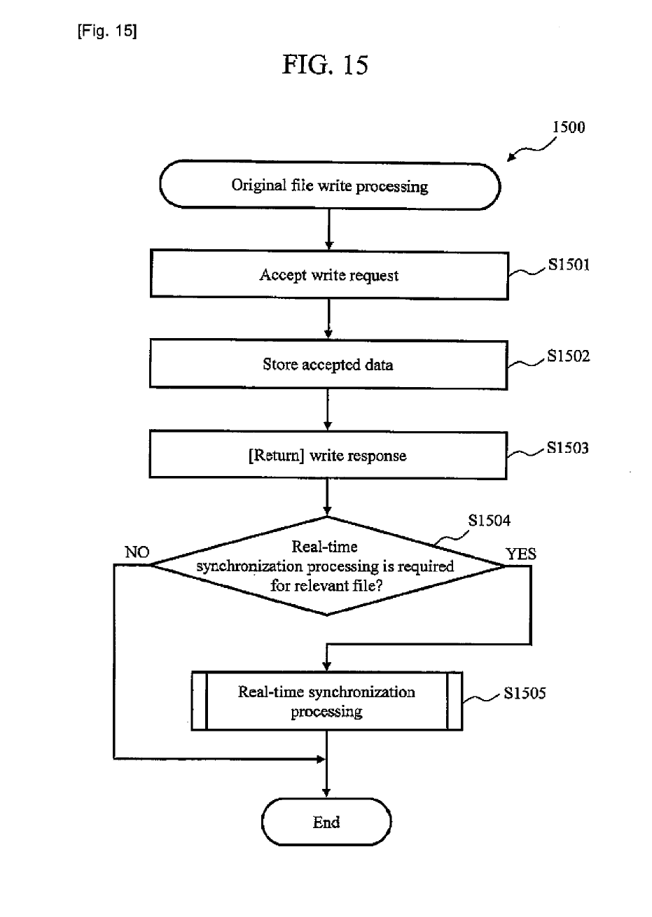

FIG. 15 is a flowchart for explaining the original file write processing by the Embodiment 3. The original file write processing is the processing in which, for example, the client 101 in the site A 100 issues a write request for the file stored in the NAS device 102 of the site A 100 and the NAS device 102 updates the relevant file. In the Embodiment 3, the real-time synchronization processing is performed by the original file write processing for the file which is the target for which the synchronization processing is performed in real time. Hereinafter, the processing shown in FIG. 15 is explained in order of the numbers of the steps. Though the explanation below assumes that the write request is processed in the NAS device 102 in the site A while the real-time synchronization processing is performed in the NAS device 112 in the site B, this is merely conveniently for the ease of understanding, and the same processing is performed in each of the sites.

Step S1501: The file system program 409 in the NAS device 102 in the site A accepts a write request from the client 101 via the file sharing server program 406.

Step S1502: The file system program 409 in the NAS device 102 stores the received data in the relevant file.

Step S1503: The file system program 409 in the NAS device 102 returns the response of the file write to the client 101 via the file sharing server program 406.

Step S1504: The file system program 409 in the NAS device 102 determines whether the real-time synchronization processing for the relevant file is necessary or not. If the real-time synchronization processing is not necessary (in case of NO at the step S1504), the original file write processing is terminated.

Step S1505: If the real-time synchronization processing is necessary (in case of YES at the step S1504), the NAS device 102 performs the real-time synchronization processing which is explained later.

Though the NAS device 102 determines at the step S1504 in FIG. 15 whether the real-time synchronization processing for the relevant file is necessary or not, whether the real-time synchronization processing is necessary or not can be appropriately set from the management terminal 124 by the system administrator or appropriately set by the user of the client 101.

It should be noted that only the update files migrated by the batched processing which is regularly performed in the remote site (site A) can be viewed in the local site (site B) in the Embodiments 1 and 2. Specifically speaking, if the file is updated for a plurality of times in each of the intervals of the batched processing, it becomes impossible to view all the versions of the file in the site B. Meanwhile, in the Embodiment 3, as the file synchronization processing is performed in real time, it is possible in the local site (site B) to view all the versions of the file updated in the remote site (site A).

<Details of Real-Time Synchronization Processing>

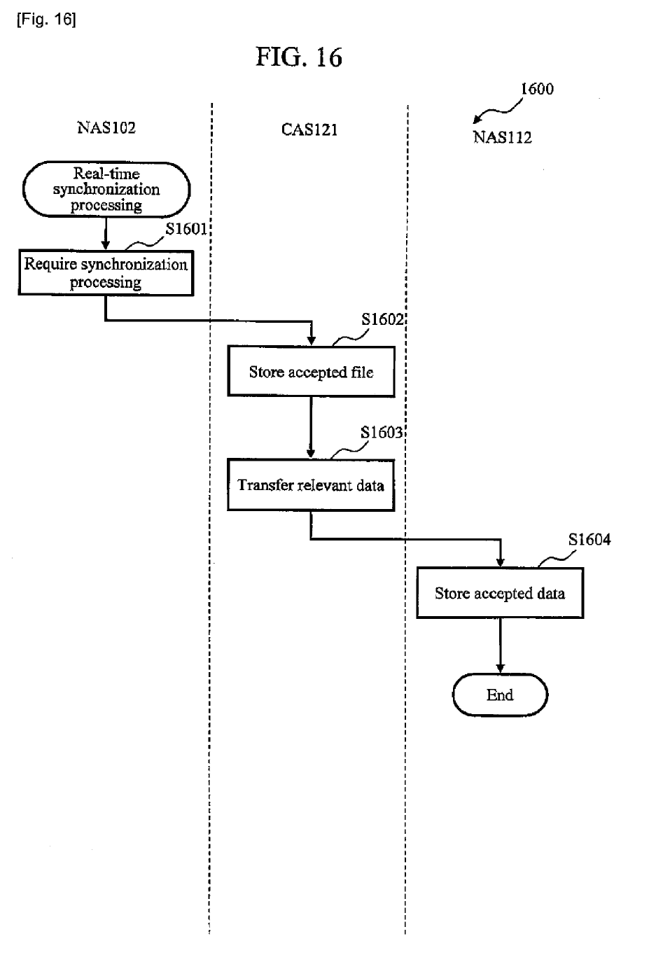

FIG. 16 is a flowchart for explaining the details of the real-time synchronization processing. The real-time synchronization processing is the processing at the step S1505 in FIG. 15. Hereinafter, the processing shown in FIG. 16 is explained in order of the numbers of the steps.

Step S1601: The file sharing client program 407 in the NAS device 102 requires the synchronization processing of the CAS device 121.

Step S1602: The file system program 508 in the CAS device 121 accepts the synchronization processing request from the NAS device 102 via the file sharing server program 506, and updates the relevant file stored in the file system FS_A_CAS220 by the received data.

Step S1603: The file system program 508 in the CAS device 121 transfers the relevant data to the NAS device 112 via the file sharing server program 506.

Step S1604: The file sharing client program 407 in the NAS device 112 receives the data from the CAS device 121 and stores the received data in the local file system FS_A_R210 in collaboration with the file system program 409.

In the processing at the step S1604 in FIG. 16, the NAS device 112 does not overwrite the existing file which is already stored and stores the same as a file which has the same path name but is of another version. For example, suffixes such as the version number and the update date may also be added to the file name. Furthermore, the file attribute information may also include the version number, by whom the file was last updated, and others. By these methods, the previous files which are already stored become referable if the client 111 wants to refer to the same.

As explained above, in the Embodiment 3, real-time file sharing among sites is realized by immediately archiving or backing up the file updated by the NAS device 102 to the CAS device 121, the CAS device 121 transferring the relevant file to the NAS device 112, and the NAS device 112 updating the relevant file immediately.

### (4) Summary

Since the present invention can be realized by adding functions by the software to the conventional technology, no infrastructure has to be additionally installed. Since the present invention requires no communication among the sites, no communication infrastructure among the sites for performing data sharing has to be additionally installed. Furthermore, since the backup data which is acquired for disaster/failure recovery can be utilized as the back-up data to be utilized, no storage has to be additionally installed in the data center either.

Furthermore, the present invention can also be realized by program codes of the software for realizing the functions of the Embodiments. In this case, storage media in which the program codes are recorded are provided to the system or the apparatus, and the computer (or the CPU or the MPU) of the system or apparatus reads the program codes stored in the storage media. In this case, the program codes which are read from the storage media are supposed to realize the functions of the above-mentioned Embodiments, and the program codes and the storage media storing the same are supposed to configure the present invention. As the storage media for providing such program codes, for example, a flexible disk, a CD-ROM, a DVD-ROM, a hard disk, an optical disk, a magnetooptic disk, a CD-R, a magnetic tape, a non-volatile memory card, a ROM, and others are used.

Furthermore, it may also be permitted that the OS (operation system) or others operating in the computer performs part or all of the actual processing in accordance with the instructions of the program codes to ensure that the functions of the above-mentioned Embodiments are realized by the processing. Furthermore, it may also be permitted that, after the program codes read from the storage media are written to the memory in the computer, the CPU or others in the computer performs part or all of the actual processing in accordance with the instructions of the program codes to ensure that the functions of the above-mentioned Embodiments are realized by the processing.

Furthermore, it may also be permitted that the program codes of the software for realizing the functions of the Embodiments are stored in the storage means such as hard disks and memories or the storage media such as CD-RWs and CD-Rs in the system or apparatus by distributing the same via the network and, at the point of use, the computer (or the CPU or the MPU) of the system or apparatus reads the program codes stored in the relevant storage means or the storage media and performs the same.

Finally, it must be understood that the processes and the technologies explained herein are not essentially associated with any specific apparatus and can be implemented by any appropriate combination of components. Furthermore, various types of general-purpose devices can be used in accordance with the instructions explained herein. It might be considered to be useful to construct a dedicated apparatus for performing the steps of the methods described herein. Furthermore, various inventions can be created by appropriate combinations of a plurality of components disclosed in the Embodiments. For example, some of components may also be deleted from all of the components shown in the Embodiments. Furthermore, the components in the different Embodiments may also be combined appropriately. Though the present invention is explained with reference to the concrete examples, all of these are explanatory, not for limitation, from all the perspectives. Those skilled in the art may understand that there are a large number of combinations of hardware, software, and firmware appropriate for practicing the present invention. For example, the above-mentioned software can be implemented by a wide range of programs or script languages such as assemblers, C/C++, pert, Shell, PHP, and Java (registered trademark).

Furthermore, the control lines and the information lines considered to be necessary for the explanation are shown in the above-mentioned Embodiments, and not all the control lines and the information lines for the product are necessarily shown. All the components may also be mutually connected.

Additionally, those having ordinary skill in the art may easily understand the other types of implementations of the present invention by considering the Description and the Embodiments of the present invention disclosed herein. The various aspects and/or components of the above-mentioned Embodiments can be used solely or in any combination in the computerized storage system comprising the data management function. The Description and the Embodiments are merely exemplary, and the spirit and scope of the present invention are shown in the subsequent Claims.

### REFERENCE SIGNS LIST

100: Site A (First sub-computer system)
110: Site B (Second sub-computer system)
120: Data center
101 and 111: Client
102 and 112: NAS device (NAS)
121: CAS device (CAS)
124: Management terminal
200: File system FS_A
210: File system FS_A_R
211: File system FS_B
220: File system FS_A_CAS
221: File system FS_B_CAS

1. An information processing system comprising:
a plurality of sub-computer systems including a first sub-computer system and a second sub-computer system; and
a data management computer system connected to the plurality of sub-computer systems, wherein
each of the plurality of sub-computer systems is a system adapted to provide, to a client computer, data stored in a storage sub-system,
the data management computer system is a system adapted to manage data migrated from each of the plurality of sub-computer systems,
the data management computer system manages backup data for the first sub-computer system, and transfers at least a portion of the backup data to at least the second sub-computer system which is distinct from the first sub-computer system,
at least the second sub-computer system stores, in a storage sub-system within the second sub-computer system, the data transferred from the data management computer system, and generates a shared file system,
the data management computer system acquires, when the data backed up from the first sub-computer system is updated, update management information for notification comprising update data information, and transfers the update management information for notification to the second sub-computer system, and,
using the update management information for notification, the second sub-computer system determines, with respect to a remote site file which is a file of the first sub-computer system that the second sub-computer system already possesses, identity in relation to an updated file at the first sub-computer system corresponding to the remote site file.

2. An information processing system according to claim 1, wherein the second sub-computer system comprises remote site file update management information for managing an update status relating to the remote site file, and updates the remote site file update management information when the update management information for notification is received from the data management computer system.

3. An information processing system according to claim 1, wherein, if the remote site file is determined as being different from the updated file, the second sub-computer system executes a data synchronization process adapted to acquire data from the data management computer system and synchronize data so that the remote site file would be identical to the updated file.

4. An information processing system according to claim 3, wherein execution of the data synchronization process by the second sub-computer system is triggered when the remote site file is accessed by the client computer.

5. An information processing system according to claim 3, wherein execution of the data synchronization process by the second sub-computer system is triggered when the update management information for notification is received from the data management computer system.

6. An information processing system according to claim 3, wherein execution of the data synchronization process by the second sub-computer system is triggered when an original file corresponding to the remote site file is updated at the first sub-computer system.

7. An information processing system according to claim 1, wherein, when deleting the remote site file itself, the second sub-computer system generates stub information of the remote site file and manages the stub information within the storage sub-system.

8. An information processing system according to claim 1, wherein the second sub-computer system:
comprises remote site file update management information for managing an update status relating to the remote site file, and updates the remote site file update management information when the update management information for notification is received from the data management computer system;
executes, if the remote site file is determined as being different from the updated file, a data synchronization process adapted to acquire data from the data management computer system and synchronize data so that the remote site file would be identical to the updated file, execution of the data synchronization process by the second sub-computer system being triggered when the remote site file is accessed by the client computer; and
deletes, if the remote site file is not accessed for a predetermined period, the remote site file from the storage sub-system while generating stub information of the remote site file to be deleted, and manages the stub information within the storage sub-system.

9. A data processing method for an information processing system comprising a plurality of sub-computer systems including a first sub-computer system and a second sub-computer system, and a data management computer system connected to the plurality of sub-computer systems, wherein each of the plurality of sub-computer systems is a system adapted to provide, to a client computer, data stored in a storage sub-system, and the data management computer system is a system adapted to manage data migrated from each of the plurality of sub-computer systems, the data processing method comprising:
a step in which the data management computer system manages backup data for the first sub-computer system, and transfers at least a portion of the backup data to at least the second sub-computer system which is distinct from the first sub-computer system;
a step in which at least the second sub-computer system stores, in a storage sub-system within the second sub-computer system, the data transferred from the data management computer system, and generates a shared file system;
a step in which the first sub-computer system updates data that is backed up in the data management computer system;
a step in which the data management computer system acquires, when the data backed up from the first sub-computer system is updated, update management information for notification comprising update data information, and transfers the update management information for notification to the second sub-computer system; and
a step in which, using the update management information for notification, the second sub-computer system determines, with respect to a remote site file which is a file of the first sub-computer system that the second sub-computer system already possesses, identity in relation to an updated file at the first sub-computer system corresponding to the remote site file.

10. A data processing method according to claim 9, wherein the second sub-computer system comprises remote site file update management information for managing an update status relating to the remote site file, and
the data processing method further comprises a step in which the second sub-computer system updates the remote site file update management information when the update management information for notification is received from the data management computer system.

11. A data processing method according to claim 9, further comprising a step in which the second sub-computer system executes, if the remote site file is determined as being different from the updated file, a data synchronization process adapted to acquire data from the data management computer system and synchronize data so that the remote site file would be identical to the updated file.

12. A data processing method according to claim 11, wherein, in the step of executing the data synchronization process, execution of the data synchronization process by the second sub-computer system is triggered when the remote site file is accessed by the client computer.

13. A data processing method according to claim 11, wherein, in the step of executing the data synchronization process, execution of the data synchronization process by the second sub-computer system is triggered when the update management information for notification is received from the data management computer system.

14. A data processing method according to claim 11, wherein, in the step of executing the data synchronization process, execution of the data synchronization process by the second sub-computer system is triggered when an original file corresponding to the remote site file is updated at the first sub-computer system.

15. A data processing method according to claim 9, further comprising a step in which, when deleting the remote site file itself, the second sub-computer system generates stub information of the remote site file, and manages the stub information within the storage sub-system.
